(19) United States
(12) Patent Application Publication
(10) Pub. No.: US 2013/0151357 A1
(43) Pub. Date: Jun. 13, 2013

(54) METHOD FOR ENABLING GROUP FOOD ORDERS

(71) Applicant: SPECIALTY'S CAFE AND BAKERY, INC., San Francisco, CA (US)

(72) Inventors: Peter Roy Havas, San Francisco, CA (US); Cameron J. Carrett, Sydney (AU)

(73) Assignee: SPECIALTY'S CAFE AND BAKERY, INC., San Francisco, CA (US)

(21) Appl. No.: 13/710,027

(22) Filed: Dec. 10, 2012

Related U.S. Application Data
(60) Provisional application No. 61/569,154, filed on Dec. 9, 2011.

(51) Int. Cl. G06Q 50/12

(52) U.S. Cl. CPC G06Q 50/12; G06Q 30/0605
USPC 705/15

(57) ABSTRACT

One variation of a method for enabling group food orders includes: receiving a food order from a order coordinator, the food order specifying a payment source and a group of participants; prompting each participant to select an alternative food item from a menu of available food items; for each participant, in response to selection of an alternative food item by the participant prior to an order deadline, adding the alternative food item to an aggregated food item order on behalf of the participant, and, in response to no selection of an alternative food item by the participant prior to the order deadline, adding a default food item to the aggregated food item order; storing the aggregated food item order on a server, the aggregated food item order reviewable by the order coordinator over a computer network; and charging the payment source for the aggregated food item order.

### CROSS-REFERENCE TO RELATED APPLICATIONS

This application claims the benefit of U.S. Provisional Application No. 61/569,154, filed on 09-Dec.-2011, which is incorporated in its entirety herein by this reference.

### TECHNICAL FIELD

This invention relates generally to the food service field, and more specifically to a new and useful method for enabling group food orders in the field of food services.

### BACKGROUND

There are many instances, such as group meetings or other group events, that can involve providing food for a group of participants. In one common practice to provide food for such group instances, an office administrator or other point person can order a wide variety of food items at his or her discretion, with an estimate of the kinds and amount of food required for meeting attendees. However, this can result in not enough food overall, can lead to a mismatch in supply and demand among the attendees, and often fails to accommodate food preferences, such as diet or food allergies, for all participants. In another common practice to provide food for such group instances, the point person can collect individual food item requests from each participant and order a precise list of food items. However, this is burdensome and time-consuming for the point person.

Thus, there is a need in the field of food services for a new and useful method for enabling group food orders. This invention provides such a new and useful method.

### BRIEF DESCRIPTION OF THE FIGURES

FIG. 1 is a flowchart representation of the method for enabling group food orders;

FIG. 2 is a flowchart representation of one variation of the method;

FIG. 3 is a flowchart representation of one variation of the method;

FIG. 4 is a graphical representation of an food order interface in accordance with a variation of the method;

FIG. 5 is a graphical representation of a participant ordering interface in accordance with a variation of the method; and

FIG. 6 is a graphical representation of an aggregated food item order interface in accordance with a variation of the method.

### DETAILED DESCRIPTION

The following description of preferred embodiments of the invention is not intended to limit the invention to these preferred embodiments, but rather to enable any person skilled in the art to make and use this invention.

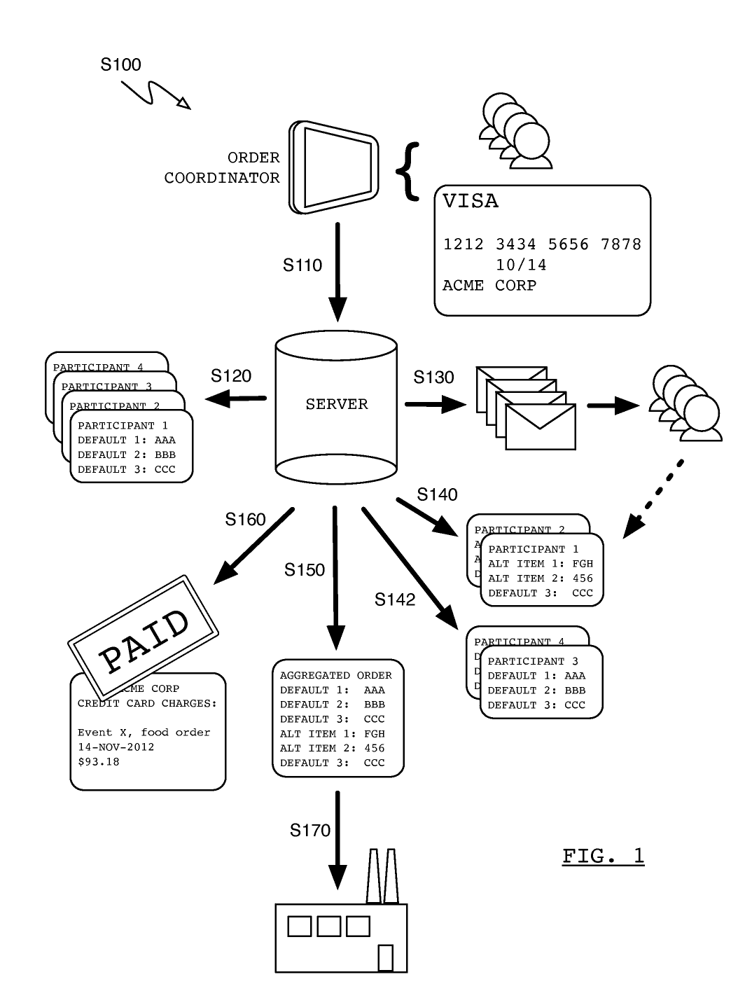

As shown in FIG. 1, a method for enabling group food orders includes: receiving a food order from a order coordinator in Block S110, the food order specifying a payment source and a group of participants; storing a suborder for each participant on a server in Block S120, each suborder including a default food item and accessible by a respective participant over a computer network; generating a notification for a particular participant in Block S130, the notification comprising a prompt to select an alternative food item for a particular suborder affiliated with the particular participant; modifying the particular suborder, stored on the server, according to an alternative food item selected by the particular participant in Block S140; combining the modified particular suborder and a suborder of each other participant in the group into an aggregated food item order in Block S150; and charging the payment source for the aggregated food item order in Block S160.

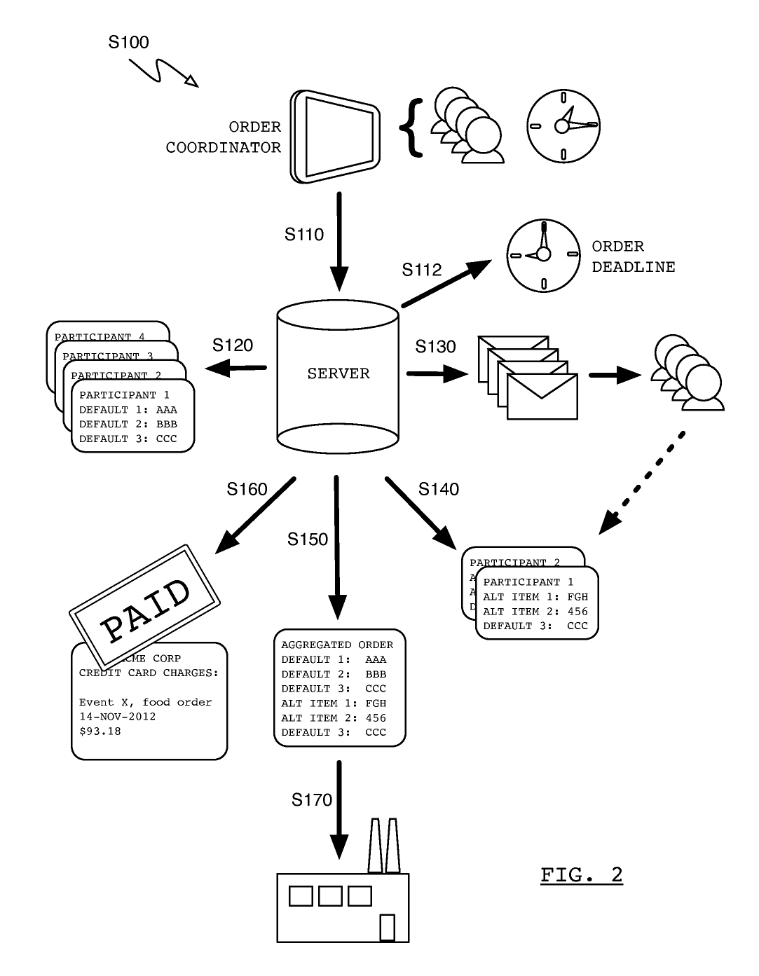

As shown in FIG. 2, a variation of the method for enabling group food orders includes receiving a food order from a order coordinator in Block S110, the food order specifying a group of participants, an order deadline, and a default food item for a suborder for each participant in the group of participants; storing the suborder for each participant on a server in Block S120, each suborder accessible by a respective participant over a computer network; prompting a particular participant within the group of participants to select an alternative food item for a particular suborder affiliated with the particular participant in Block S130; modifying the particular suborder, stored on the server, according to an alternative food item selected by the particular participant in Block S140; in response to expiration of the order deadline, combining the modified particular suborder and a suborder of each other participant in the group into an aggregated food item order in Block S150; and submitting the aggregated food item order to a food fulfillment service in Block S170.

As shown in FIG. 1, another variation of the method for enabling group food orders includes: receiving a food order from a order coordinator in Block S110, the food order specifying a payment source and a group of participants; prompting each participant to select an alternative food item from a menu of available food items in Block S130; for each participant, in response to selection of an alternative food item by the participant prior to an order deadline, adding the alternative food item to an aggregated food item order on behalf of the participant in Block S140, and, in response to no selection of an alternative food item by the participant prior to an order deadline, adding a default food item to the aggregated food item order on behalf of the participant in Block S142; storing the aggregated food item order on a server, the aggregated food item order reviewable by the order coordinator over a computer network in Block S150; and charging the payment source for the aggregated food item order in Block S160.

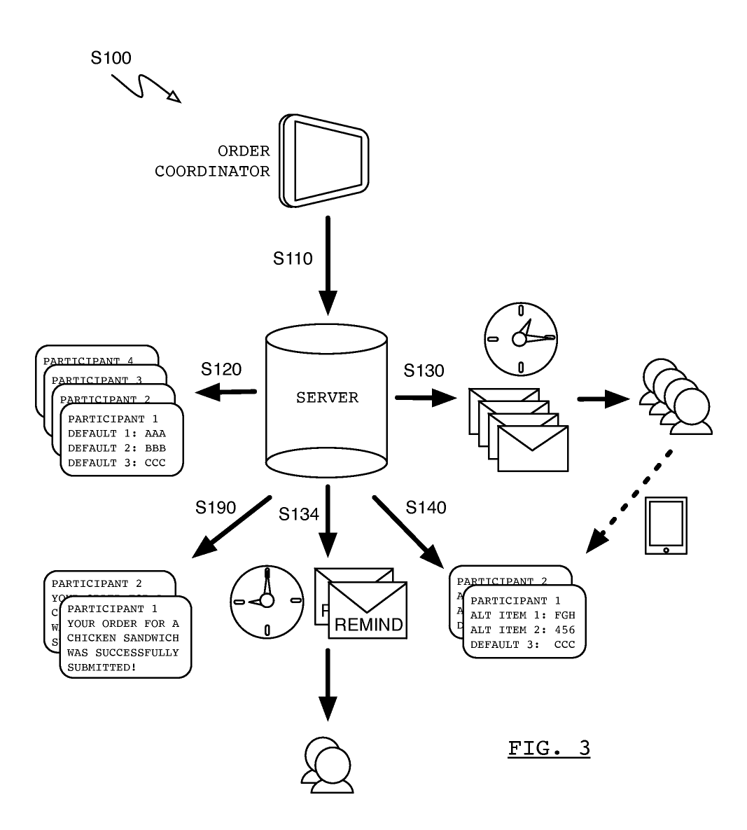

The method and variations thereof can also include setting an order deadline that is prior to a meal time specified in the food order in Block S112 (shown in FIG. 2) and generating a second notification for the particular participant in Block S134 (shown in FIG. 3), the second notification comprising a reminder to select an alternative food item. The method and variations thereof can further include transmitting confirmation of the aggregated food item order to the order coordinator and transmitting confirmation of each suborder to each participant in the group of participants in Block S190.

The method can function to streamline a process for ordering food for a group event by collecting a minimum of information, such as a payment source and a list of participants, from an order coordinator, issuing a default menu item for each participant, and prompting each participant to customize his food order. The method collects alternative food item selections from one or more participants and combines these with a default food item for each participant who failed to select alternative food item. Generally, the method can enable participants, designated in a food order entered by an order coordinator, to enter respective orders from different locations and/or at different times independent of a single payment or reduced number of payments for an aggregated food item order that includes a meal item selection for each designated participant. The method further enables an order coordinator to provide group participants the opportunity to select a preferred meal item while guaranteeing a meal item for all participants in the group event, even for those who failed to submit a meal selection or preference. For example, the method can be applied to an office lunch, wherein an office manager provides an email address for each participant in the office lunch, a company credit card number, and a time and date of the lunch, and wherein the method notifies each participant via email, directs each participant to an online menu, stores alternative food item selections by each participant, and submits a group order for the alternative food item selections and default food items (where applicable) to a local restaurant or café. However, the method can be implemented for any other office meeting, social gathering, presentation, group event, etc. in which it may be desirable to provide food to event participants.

The method can be implemented by a restaurant, a diner, a café, a take-out meal service, a catering service, or any other food-related business or industry to enable personalized orders by individual participants within a group of participants. A particular food-related business can host the method to support streamlined group ordering, wherein the host business also fulfills at least some of items in the aggregated food item order once submitted, such as by the order coordinator or automatically upon an order deadline. For example, the method can be implemented by a restaurant or store to enable a process for ordering ready-to-eat food products (e.g., sandwiches, salads, soup, drinks, desserts) through Internet- or network-based orders. Alternatively, the method can be implemented as a standalone system that augments one or more food-related businesses, such as multiple local cafés and take-out restaurants. Generally, the method can aggregate a personalized food item suborder of each participant into an aggregated food item order substantially prior a specified event, such as by 8 am on the day of a 12:30 pm office lunch meeting. Alternatively, the method can be implemented substantially in real time to quickly aggregate disparate food orders, such as when a traveling high school basketball team stops at a fast food restaurant and a coach offers to buy dinner for all of the players.

The method can alternatively enable multiple people or entities to select a desired kind and/or amount of any other suitable item and to aggregate multiple selections into a single order or reduced number of orders. For example, the method can be used to aggregate multiple preferences for a household grocery shopping list or movie rental list. In another example, the method can be used by a group of individuals to collectively satisfy a minimum order requirement for a delivery or other event, such as an order requirement that overall order cost exceed $25.00, wherein a default $5 item is affiliated with each of five participants. In yet another example, the method can be used by a school bookstore to set a default book order for students, enable book order customization by each student, submit an aggregated book order for all students after a deadline, and fulfill customized book orders for each student. The method can therefore additionally or alternatively be implemented by a household, a grocery store, a wedding or other gift registry service, a school (e.g., college) bookstore, or any other suitable entity or service.

The method can therefore be implemented by a computer system, such as a cloud-based computer (e.g., Amazon EC3), a mainframe computer system, a grid-computer system, or any other suitable computer system. Some or all of the Blocks of the method can be implemented by one or more mobile computing devices used by the order coordinator and/or one or more participants, such as a tablet or smartphone. Blocks of the method can also be accessible through a web browser and/or through a native application executing on any other computing device, such as a laptop computer, a desktop computer, a tablet, a smartphone, a personal data assistant (PDA), a personal music player, etc. Additionally or alternatively, Blocks of the method can be implemented remotely, such as on a remote server or over a distributed network of computing devices. In one implementation, the method is implemented as a set of web browser interfaces (e.g., webpages), including an order coordinator interface through which the order coordinator can enter a food order and at least one participant interface through which a participant can select an alternative food item or otherwise customize a personal order within the aggregated food item order. The method can additionally or alternatively be implemented as a set of mobile interfaces, each accessible through a native applicable executing on a mobile computing device, such as a smartphone or tablet. For example an order coordinator can enter food order details through a web browser (e.g., on a desktop computer), the method can deliver a notification to a smartphone carried by each designated participant, and each designated participant can open a personal suborder and select an alternative food item through a native menu application executing on the smartphone.

The computer system can also interface with local or remote databases, such as a menu of available food items, an order or payment profile of an order coordinator, a list of favorite food items of a participant, or a digital map and traffic information (e.g., for local delivery of an aggregated food item order). Furthermore, the computer system can communicate notifications, reminders, order confirmations, or other information to an order coordinator, one or more participants, and/or a specified or associated food fulfillment service. For example, the method can distribute personal or aggregate order information through an email, SMS text message, or in-application notification on a mobile phone or tablet. However, the method can be implemented by any another computer system in any other suitable way.

As shown in FIGS. 1 and 2, Block S110 of the method recites receiving a food order from an order coordinator, the food order specifying a payment source and a group of participants. Block S110 can further include receiving food order settings from the order coordinator. By receiving the food order and/or food order settings from the order coordinator, Block S110 functions to establish participant, order, and order fulfillment details for the aggregated food item order. Generally, Block S110 can collect identification information for each participant in the group of participants and a payment source for the food order such that Block S130 can communicate with one or more participants directly and such that Block S160 can complete the order by providing appropriate payment information for the order. Block S110 can also collect information related to the group event, such as where the event will occur (e.g., a physical address, a conference room number, an auditorium name, a business) and when the event will occur (e.g., date and time). For example, by collecting location-based data, Block S110 can enable Block S170 to specify a delivery location for the aggregated food item order. By collecting event timing data, Block S110 can enable Block 5112 to set an order deadline for participant order customization and/or aggregated food item order submission such that a food fulfillment service (e.g., restaurant) has time to prepare and deliver the food items in the aggregated food item order.

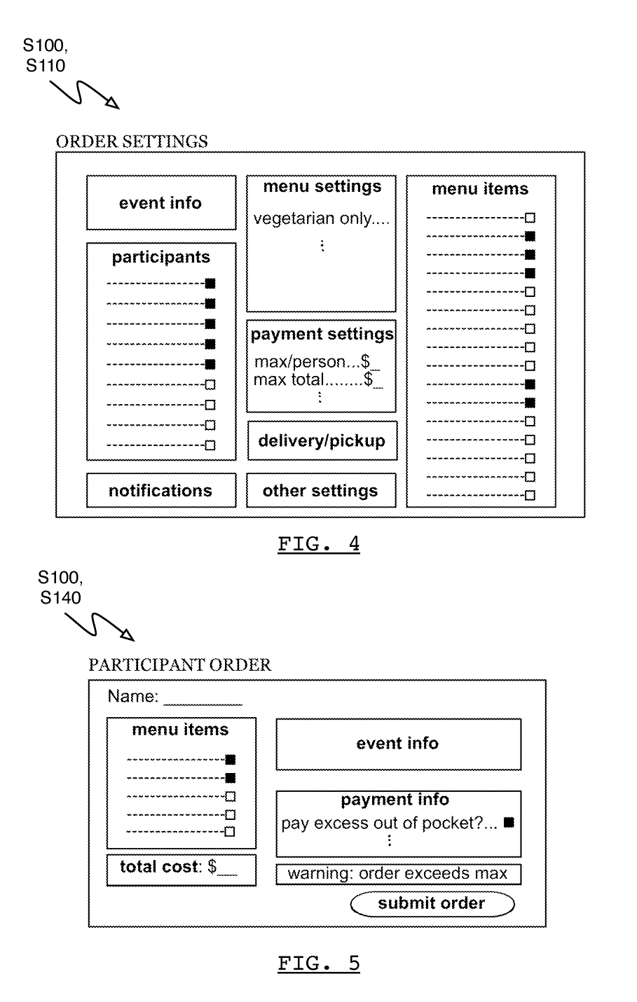

The order coordinator can be a single person or several authorized people. For example, Block S110 can receive details of the food order from an office manager, an event coordinator, a camp counselor, or an athletics coach. In one implementation shown in FIG. 4, Block S110 can include displaying order details and/or settings on a display, such as a webpage display on a computer or a kiosk. For example, the order coordinator can navigate to a webpage and make selections corresponding to desired order details or settings. The display can be connected to a network coupled to a server for storing the food order and/or food order settings. The order coordinator can then manually enter email address, phone numbers, or other communication identification handle of each participant or by selecting participant contact information by interfacing with a digital contact list. Block S110 can thus enable the order coordinator to propagate a list of participants in the group. Block S110 can further enable the order coordinator to name and store the group of participants. For example, Block S110 can receive account login information from the order coordinator, access past names participant groups, and enable the order coordinator to select a particular past participant group, wherein past food order details for the participant group, such as participant contact information and payment information, are automatically loaded into the current food order. Block S110 can implement private order coordinator accounts to identify repeat customers and further streamline food order detail entry for repeat events (e.g., weekly work lunches) for an order coordinator.

Generally, Block S110 can include receiving order settings from one or more of the following categories:

Order settings of a first category enable the order coordinator to select or enter event information. Examples of event information include the date, time, and place of an event requiring food (or another suitable kind of item). The event information can include a title or name (e.g., “Board of Directors Meeting”) summarizing the kind of event. This information can be pertinent to the order coordinator to manage and keep track of multiple different events requiring food, and/or to notify the designated participants of the relevant event. The event information can include a list of one or more designated participants (e.g., event attendees) in the aggregated food order. Block S110 can also collect event information relates to a period of time over which the one or more designated participants can submit an order, such as a particular week or month (or any suitable time period) during which a child, company employee, or other participant can submit orders for one or more meals that are paid or subsidized by the order coordinator. For example, the order coordinator can enter a deadline by which participants must edit their respective suborders.

Order settings of a second category can enable the order coordinator to select or enter menu settings, which can place restrictions or guidelines on food items available for participant selection. Block S110 can therefore implement order settings of the second category to form a menu subset, thus enabling the order coordinator to select only a subset of a menu provided by a food establishment, wherein only the subset is presented to and selectable by the designated participants. For example, an order coordinator entering a food order for a middle school class lunch can eliminate all potentially “messy” and unhealthy food items, such as soups and cakes, from an available menu. In one implementation, Block S110 receives order settings of the second category that restrict the selectable menu subset to certain specific items on the menu (e.g., “turkey and ham sandwich”) or certain classes of items on the menu (e.g., “vegetarian”, “peanut-free”) to cater to food allergies or relevant customs. In another implementation, Block S110 receives order settings of the second category that restrict the selectable menu subset to certain items that are approximately or no more than a certain price (e.g., $10). In yet another implementation, Block S110 receives order settings of the second category that restrict the selectable menu subset to certain items or total food order satisfying a particular nutritional metric, such as having approximately or no more than a particular calorie, fat, or sodium content, or other suitable health-related or other nutritional metric. In a further implementation, Block S110 receives order settings of the second category that restrict the selectable menu subset to certain items accommodating another factor, such as transportability. For example, for a group trip involving extensive travel, the order coordinator can select menu settings to discourage participants from individually ordering a soup that risks being spilled, or hot food items that are best consumed warm. In some implementations, some or all of these menu settings can be hard limits such that participants are presented only with a menu subset dictated by the order coordinator based on the menu settings. However, in some embodiments, some or all of these menu settings can merely be guidelines such that particular food items are indicated as preferable or having a particular preferred characteristic. For example, a company hosting a group event can use order settings of the second category to encourage, but not mandate, healthful eating. Furthermore, these menu settings can be preset filters that the order coordinator can select, and/or the order coordinator can select certain items to be included or excluded in the menu subset based on his discretion approximately adhering to one or more of these menu setting types.

Similarly Block S110 can collect a menu setting that defines or relates a default food item for one or more participants in the group. The default food item can be a previously saved “favorite” food item of participants, a generic default order generated by popularity determined in any suitable manner, a default order selected by the order coordinator, or any suitable default food item. The menu setting can specify a single default food item, multiple default food items, or a complete default meal (e.g., main, side, and drink) for each participant. In one example implementation, Block S110 receives an order coordinator selection for a food item, for each suborder, that is a vegetarian sandwich since a vegetarian sandwich can be substantially likely to fulfill dietary and allergy needs of substantially all participants. In another example implementation, Block S110 enables the order coordinator to review a past food item ordered by a particular participant and records an order coordinator selection of the past food item as the default food item for the particular participant. For example, Block S142 can apply the past food item as the default food item for the particular participant if the particular participant fails to select an alternative food item within an allotted order window. The order coordinator can similarly select a “favorited” food item (from a designated restaurant) of a particular participant as a default item for the particular participant. In yet another example implementation, Block S110 can receive meal requirements of the group from the order coordinator. For example, if the order coordinator knows that at least one participant has a peanut allergy, at least one is vegetarian, and at least one is gluten-free, the order coordinator can select check boxes for peanut allergy, vegetarian, and gluten-free. Block S110, Block S120, and/or Block S142 can subsequently automatically select an appropriate default food item for one or more participants based on aggregate meal requirements of the whole group. However, Block S110 can receive any other relevant information for or related to a default menu item for one or more participants in the group.

Order settings of a third category can enable the order coordinator to select or enter payment options. In a one implementation, Block S110 collects a payment option that includes a payment source and billing information that can be implemented by Block S170 to complete the aggregated food item order. The payment option can be a single payment source (e.g., a company credit card) or multiple payment sources (e.g., credit cards of several parent hosts on a middle school field trip). In a another implementation, Block S110 collects a payment option that includes budget settings, such as a minimum and/or maximum total (pre-tax or post-tax) cost of the aggregated food item order (e.g., $120 for ten participants) or a minimum and/or maximum order cost per person (e.g., $10 per person). The order coordinator can also select other suitable payment options for managing the budget. In one example implementation, the order coordinator can enable a particular participant who has an individual order cost exceeding the maximum allowed order cost per person to pay for at least some of his order (e.g., the excess amount), such as with his own credit card. In another example implementation, the order coordinator can select or designate an acceptable excessive budget amount, such as a few dollars over the target budget for the aggregated food item order, that can function as a buffer to allow more lenient or flexible budget limits. In yet another example implementation, the order coordinator can select or designate a subsidy amount that will be applied to the order cost per person or per order. For example, the order coordinator can select a subsidy option, such as a “zero subsidy” option, such that some or all participants must pay for a portion or all of their respective orders themselves.

Order settings of a fourth category can enable the order coordinator to select or enter notification settings. Generally, Block S110 can receive notification settings from the order coordinator such that Block S130 can automatically generate ordering invitations for designated participants, such that Block 134 can automatically generate ordering reminders for a delinquent participant, and/or such that Block S190 can automatically generate an order status update for the order coordinator and/or participants. The notification settings can include a mailing list or group of designated participants (e.g., “Marketing” or “Engineering”) that the order coordinator can use to simultaneously select and invite multiple designated participants. The notification settings can also relate to recurring events, such as weekly meetings involving some or all repeated attendees. For example, Block S110 can cooperate with Block S130 to generate recurring invitations for designated participants based on the notification settings. Block S110 can also cooperate with Block S130 to automatically populate calendars of the designated participants, such as through network communications with the event, event or food ordering reminders, or other suitable notification or communication channels.

Order settings of a fifth category can enable the order coordinator to select or enter procurement options for the aggregated food item order. Generally, Block S110 can received a procurement options that indicates one of a delivery option and a pick-up option for the aggregated food item order. For example, if the delivery option is selected, Block S110 can prompt entry of further procurement details that include one or more of a delivery address, a preferred delivery time, and a delivery time window. Alternatively, if the pick-up option is selected, Block S110 can prompt entry of further procurement details that include one or more of a particular restaurant or store pick-up location, a pick-up time, and a pick-up time window. Block S110 can also prompt the order coordinator to select a first portion of the aggregated food item order for delivery and a second portion of the aggregated food item order for pick-up.

Block S110 can also receive other suitable order setting or options. For example, the order coordinator can specify additional items to add to the aggregated food item order, such as a particular number and kinds of cookies, chips, or drinks, such as if the individual participant orders do not include these items. In another example, the order coordinator can specify a shared group item, such as a cake to be shared amongst the group for an event that is a birthday or other celebration. In yet another example, the order coordinator can specify whether peripherals such as disposable utensils or napkins can be excluded from or should be included in the order. However, Block S110 can receiving any other order setting including any other relevant information. Furthermore, any of the order settings can be saved as default order settings for quick access in future food orders by the order coordinator.

One variation of the method can therefore also include Block S112, which recites setting an order deadline that is prior to a specified meal time. Block S112 can therefore function to set a deadline for participant selection of an alternative food item for his respective suborder. In an implementation in which Block S110 receives an order setting that specifies a meal time, such as noon for a group lunch or 8:30 am for a group breakfast, Block 5112 can account for the specified meal time and any other relevant factor to set the order deadline. For example, Block S112 can account for a preferred delivery time, a delivery option (e.g., pickup or delivery), a distance between the restaurant and the group location, current or estimated future traffic between the restaurant and the group location, business hours for the restaurant, estimated meal preparation time, busy and slow hours for the restaurant, and/or other pending meal orders and times for other groups in the area in determining the order deadline. Alternatively, Block S112 can select a the order deadline that is a predetermined lead time for the meal, such as twelve hours before the meal that is a breakfast, four hours before the meal that is a lunch, two hours before a meal that is an afternoon snack, and six hours before a meal that is a dinner. Block 5112 can also determine the order deadline based on an order deadline selected by the order coordinator. However, Block S112 can function in any other way to set the order deadline.

As shown in FIGURE, Block S120 of the method recites storing a suborder for each participant on a server, each suborder including a default food item and accessible by a respective participant over a computer network. Generally, Block S120 functions to store details of the order, including order settings, on a remote server such that the details can be accessed and implemented in subsequent Blocks of the method. The server can be a remote server connected to a computer network, a local storage drive, or any suitable storage for saving order settings from the order coordinator.

Block S120 can further generate a suborder per participant based on the order settings. In one example implementation, Block S120 specifies one food suborder for each participant, wherein each suborder defines a maximum suborder cost (e.g., $15), a default main dish (e.g., a vegetarian sandwich), a default side dish (e.g., coleslaw), a default desert (e.g., a cookie), and a default drink (e.g., iced tea). Block S120 can further enable participant access to a respective suborder through a computer network connected to the server, such as over the Internet through a web browser or through a food ordering application executing on an Internet-connected mobile computing device (e.g., smartphone). Block S120 can therefore further cooperate with Block S110 and/or Block S142 to select one or more default food items for one or more participants within the group. However, Block S120 can function in any other way to store one or more suborders for one or more respective participants within the group.

As shown in FIGS. 2 and 3, Block S130 of the method recites prompting each participant to select an alternative food item from a menu of available food items. In one variation, Block S130 similarly recites prompting a particular participant within the group of participants to select an alternative food item for a particular suborder affiliated with the particular participant. In another variation, Block S130 similarly recites generating a notification for a particular participant, the notification comprising a prompt to select an alternative food item for a particular suborder affiliated with the particular participant. Generally, Block S130 functions to notify each participant of the food order entered by the order coordinator, the suborder for a respective participant, and the availability of alternative food items that the respective participant can substitute for a default food item specified in the participant's respective suborder. Block S130 can further notify each participant of the order deadline and specify that alternative food item selections must be made prior to expiration of the order deadline. Block S130 can inform the participants by transmitting notifications, including any or all of the foregoing information, through a suitable communication channel prior to the order deadline. For example, Block S130 can transmit a notification via email, as SMS text message, as a calendar update or alert, as a public or private online social network message, or an as in-app notification on a mobile computing device (e.g., smartphone) carried by a participant.

Block S130 can generate the notification that further includes a link to a menu of available food items, such as online menu interface that enables selection of an alternative food item. For example, Block S130 can generate a notification including a hyperlink that points to a participant order interface accessible though a web browser. In another example, Block S130 can generate a notification that, when selected, opens a native food ordering application on a smartphone carried by a participant. When a participant selects the link, Block S130 can direct the participant to a personalized order interface that automatically connects the participant with the food order, thus avoiding a login step for the participant. Alternatively, Block S130 can generate a login name, password, food order or suborder name, food order or suborder number, etc., wherein a respective participant can enter one or more of the foregoing data to access and modify a respective suborder. Alternatively, Block S130 can enable a participant to select an alternative food item from directly within a respective notification.

Block S130 can also generate the notification that includes a recommendation for an alternative food item for the particular participant. For example, Block S130 can analyze a food item order history of the particular participant and include recommendation for a previously-ordered food item within a notification to the particular participant, such as based on a most recent food item selection or a particularly common. Block S130 can also include in the notification a recommendation for a food item previously “favorited” by particular participant. However, Block S130 can function in any other way to notify the participants of the food order, to direct each participant to a venue through which to modify a respective food order, and/or to recommend a particular food item to a particular participant.

As shown in FIG. 3, one variation of the method further includes Block S134, which recites generating a second notification for the particular participant, the second notification comprising a reminder to select an alternative food item. Block S134 functions to remind a participant of the suborder and an opportunity to modify the suborder. Generally, Block S134 can transmit a notification similar to that of Block S130 to a participant if the participant fails to confirm or edit a respective suborder within a threshold period the initial notification of Block S130 is transmitted. For example, if Block S130 transmits an initial notification of the food order forty-eight hours before the order deadline, Block S134 can transmit a reminder to a delinquent participant twelve hours before the order deadline. Block S134 can transmit the reminder to a delinquent participant a predetermined period of time before the order deadline or scheduled meal time (e.g., several hours) or according to a percentage of time between the initial notification and the order deadline (e.g., once 75% of this period expires). However, Block S134 can function in any other way to remind a participant of the food order and/or suborder.

As shown in FIGS. 1 and 2, Block S140 of the method recites, for each participant, adding an alternative food item to an aggregated food item order on behalf of the participant in response to selection of an alternative food item by the participant prior to an order deadline. Block S140 can similarly recite modifying a particular suborder, stored on the server, according to an alternative food item selected by a particular participant. Generally, Block S140 functions to capture a food item selection by a participant and to update a respective food order for the participant by replacing a default food item in the order with the alternative food item selected by the participant. The method can implement Block S140 for each participant who selects an alternative food item within an allotted suborder modification period.

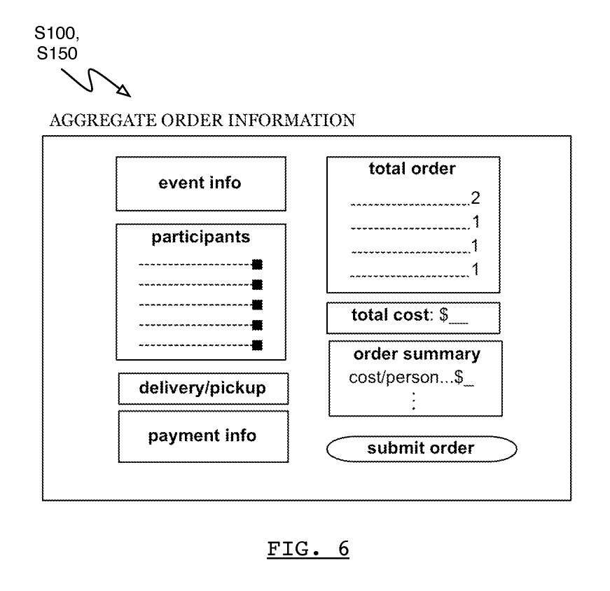

Block S140 can further compare a food item selection again order settings specified by the order coordinator to ensure that an alternative food item selection adheres to rules or details for the food order. For example, Block S140 can identify, flag, and/or prevent selection of a food item that exceeds a maximum per-item cost, that exceeds a maximum total suborder cost either independently or in combination with other items in the suborder, that does not meet nutritional requirements, that is too messy, that requires utensils, that fails to meet food allergy needs, etc. For improper alternative food item selections, Block S140 can warn a participant of the problem, recommend another alternative, notify the order coordinator, and/or handle the incorrect food item selection in any other suitable way, such as show in FIG. 5. However, for alternative food item selections that meet order setting guidelines, Block 140 can automatically remove a default food item from a participant's suborder and place the default food item with the participant's selection.

Block S140 can further enable a participant to customize a particular food item and subsequently update a suborder for the participant with a customized food item. For example, Block S140 can receive a customized list of toppings for a sandwich or an option to toss a salad with dressing or to leave the dressing on the side. In another example, Block S140 can implement a “create sandwich” interface, such as described in U.S. Patent Application No. 2007/0061225, which is incorporated in its entirety by this reference. Block S140 can further cooperate with Block S120 and/or Block S150 to store customized food suborder for a particular participant such that the order coordinator can select the customized food suborder for the particular participant when initiating a future food order. Block S140 can similarly add an alternative food item selected by a particular participant to a list of favorite food items of the particular participant, and Block S110 and/or Block S120 can select a default food item for the particular participant from the list of favorite foods items of the particular participant.

As shown in FIG. 1, one variation of the method includes Block S142, which recites adding a default food item to the aggregated food item order on behalf of a participant in response to no selection of an alternative food item by the participant prior to an order deadline. Generally, Block S142 can confirm a default food item selected for a participant Block S110 and/or Block S120 if the participant fails to select an alternative food item within an order period (e.g., before an order deadline). In an example implementation, Block S110 and/or Block S120 can select a default food item for a particular participant based on a food item order history of the participant, and Block S142 can confirm the default food item based on a active or passive action of the particular participant. In an example of active confirmation of the default food item, a particular participant can access his respective suborder (e.g., through a respective notification), review a default food item within the suborder, and opt to leave the default selection unchanged. Alternatively, in an example of passive confirmation of the default food item, a particular participant can fail to access his respective suborder within an allotted order modification period. The method can implement Block S142 for each participant who passively or actively does not select an alternative food item within an allotted suborder modification period.

Block S140 and/or Block S142 can therefore function to update the food order and/or suborders stored on the server in Block S120. However, Block S140 can function in any other way to add an alternative food item to an aggregated food item order on behalf of a participant. Furthermore, Block S142 can function in any other way to add a default food item to the aggregated food item order on behalf of the participant.

In one variation shown in FIG. 4, the method can further enable the order coordinator to define customized order settings that selectively limit or guide a variety of food items available to the participants for selection, thereby enabling an order coordinator a degree of control over contents of the aggregated food item order, such as total cost, cost per participant, food types, and/or any suitable characteristic of items in the food order. The method can therefore include modifying a menu of food items based on the order settings, such as by generating a menu subset reflecting limitations or guidelines provided by the order settings. The menu can be modified into a menu subset in one or more of several manners as a result of the received order settings, as described above. Generally, modifying the menu can include modifying the menu based on the menu settings, such as excluding, including, or marking particular menu items based on item name, item type, nutritional metrics, ingredients, or any suitable characteristic. The modified menu subset can be stored to a server and linked to correspond to the relevant event. Furthermore, the menu can be altered multiple times to provide a set of different modified menus for different designated participants.

In the foregoing variation, Block S140 can include presenting the modified menu of food items to each participant to enable participants, at various locations and/or times, to select respective individual food items for respective suborders that will be combined into the aggregated food item order in Block S150. As shown in FIG. 5, in this variation, Block S140 can include displaying the modified menu on a computer screen (e.g., webpage display), mobile graphical interface (e.g., on a mobile phone through a webpage or application program) or other suitable viewable display, and allowing a participant to select one or more items from the modified menu. Before, during, and/or after presenting the modified menu, Block S140 can also include querying a participant for a name, login (e.g., user name and password) information, or other identification information. For example, the order form can be accessible after complete participant login to a customer account that saves participant order information (e.g., favorite food item, previous food item orders) or after a full registration of a new customer account. In another example, the order form can be accessible after a partial account registration, which can allow a “new customer” participant, who is a new customer, does not have a customer account, or forgot his account login information, to submit a suborder necessitating creation of an entirely new account. For example, partial account registration can require only a name and an email address.

As shown in FIGS. 1 and 6, Block S150 of the method recites storing the aggregated food item order on a server, the aggregated food item order reviewable by the order coordinator over a computer network. Block S150 can similarly recite combining a modified suborder of a particular participant and a suborder of each other participant in the group into an aggregated food item order, such as in response to expiration of an order deadline. Generally, Block S150 functions to combine a suborder, default food item, and/or an alternative food item selection for each participant in the group of participants into an aggregated food item order including at least one food item for each participant in the group. Block S150 can thus output a single food item order that can be submitted to a single food fulfillment service in a single one-time communication with the expectation of fulfillment of each and every food item in the order by the single food fulfillment service.

In one example implementation, if all participants in the group responded to a notification of Block S130 and/or Block S134 by replacing all default food items with alternative food items, Block S150 can combine the alternative food items into the aggregated food item order. In another example implementation, if some but not all participants in the group responded to a notification of Block S130 and/or Block S134 by replacing a default food item with an alternative food item or if all participants in the group replaced some but not all default food items with alternative food items, Block S150 can combine alternative food item selections and remaining default food items into the aggregated food item order. In yet another example implementation, if no participant in the group responded to a notification of Block S130 and/or Block S134 by replacing a default food item with an alternative food item, Block S150 can combine the default food items into the aggregated food item order.

In a variation in which the method enables the order coordinator to specify two or more food fulfillment services (e.g., two restaurants, a café and a coffee shop, a grocery store and a candy store, etc.), Block S150 can further place participant food items into distinct aggregated food item orders, each suitable for fulfillment by a particular food fulfillment service in the set of food fulfillment services. For example, for participant food items selections that include sandwiches and ice cream, Block S150 can generate a first aggregated food item order for sandwiches and designate this first aggregated food item order for a takeout café, and Block S150 can generate a second aggregated food item order for ice cream and designate this second aggregated food item order for a takeout ice cream parlor. However, Block S160 can function in any other way to combine suborders into the aggregated food item order

As shown in FIGS. 1 and 2, one variation of the method further includes Block S170, which recites submitting the aggregated food item order to a food fulfillment service. In one implementation, once the order deadline passes and Block S150 assembles the aggregated food item order, Block S170 can automatically send the aggregated food item order to a designated food fulfillment service (e.g., a designated restaurant, a designated café, a designated bakery, etc.). In this implementation, Block S170 can submit the aggregated food item order in a digital (e.g., electronic) format. For example, Block S170 can automatically generate and transmit an email that includes a list of each default and/or alternative food item in the aggregated food item order. In another example implementation, Block S170 can automatically populate an online shopping cart for the order coordinator and automatically submit the contents of the shopping cart to the food fulfillment service or submit the contents of the shopping cart in response to confirmation from the order coordinator. In a further implementation, Block S150 can interface with an online ordering system hosted by the food fulfillment service to automatically select and submit a digital form of the aggregated food item order directly to the food fulfillment service.

Block S170 can also include food order details in the submission of the aggregated food item order to the food fulfillment service. For example, Block S170 can include a selected delivery option, a delivery address, and a preferred delivery time or a delivery window. In another example, Block S170 can specify the names of each participant and the particular food item(s) in each participant's suborder such that the food fulfillment service can package each suborder into a separate sealed and labeled pouch, sack, box, or other container, thus enabling each participant to grab a single container with his name on it and including all items in his suborder (or all items aside from a drink). Block S170 can also include contact information, such as an email address of phone number, for the order coordinator such that the food fulfillment service and/or a food delivery service can contact the order coordinator, such as to confirm an order or for help in locating a delivery location, respectively. However, Block S170 can communicate any other relevant information to the food fulfillment service when submitting the aggregated food item order. Furthermore, in a variation in which a food delivery service separate from the food fulfillment service is scheduled or selected to make delivery of the aggregated food item order to the order coordinator (or other location), Block S170 can handle a separate communication or relevant information to the food delivery service, such as a delivery location, order pickup time, order number, delivery time or window, estimated traffic conditions, and/or estimated travel time. However, Block S170 can function in any other way to submit the aggregated food item order to a food fulfillment service.

As shown in FIGS. 1 and 2, Block S160 of the method recites charging the payment source for the aggregated food item order. Generally, once Block S170 submits the aggregated food item order to the food fulfillment service (and food delivery service), Block S160 functions to pay the food fulfillment service for the aggregated food item order by charging the cost of the order to the payment source. In one example implementation, Block S160 charges the payment source automatically, such as when all designated participants have submitted respective suborders. In another example implementation, Block S160 charges the payment source after authorization or approval from the order coordinator or other point person.

The payment source can be a personal or company debit card, credit card, stored-value (e.g., gift) card, bank account, checking account, or any other suitable form of digital currency or payment. In an implementation in which the order coordinator has selected a local delivery option, Block S160 can include a delivery fee in the charge amount for the food order if the food fulfillment service provides the delivery, or Block S160 can charge a separate transaction to the payment source for the food delivery service that is distinct from the food fulfillment service. In an implementation in which multiple payment options are entered for the food order, Block S160 can also handle shared charges across the multiple payment sources. For example, Block S160 can split the cost of the food order (and delivery) evenly across the payment sources or charge a first payment source up to a specified amount and then shift to one or more secondary payment sources to cover the remaining balance.

Alternatively, Block S160 can support a cash or check payment by the order coordinator, such as by generating a printable product order or receipt, wherein the order coordinator can submit a cash or check payment with the product order or recipient to delivery personnel upon local delivery or to the food fulfillment service directly upon pickup. However, Block S160 can function in any other way to support payment for the aggregated food item order.

As shown in FIG. 3, one variation of the method further includes Block S190, which recites transmitting confirmation of the aggregated food item order to the order coordinator and transmitting confirmation of each suborder to each participant in the group of participants. Generally, once the order deadline passes and Block S150 combines suborders from each participant into the aggregated food item order, Block S190 can make a list of food items and/or other details of the aggregated food item order available to order coordinator, such as to enable order coordinator review the food order, check suborder statuses, check total food order cost, etc. For example, Block S190 can transmit an email or other notification to the order coordinator, wherein the email or notification includes the list of food items and/or other relevant details. In another example, the order coordinator can review the aggregated food item order through an order coordinator interface within a food ordering website accessible through a web browser. The communication to the order coordinator can also include confirmation that the aggregated food order was submitted to the food fulfillment service, that all food items selections were supported, that the payment source was successfully applied, that an error in the order occurred, that a particular food item has not been or will not be fulfilled, that the order failed, the number of participants who responded to the food order, and/or any other relevant information, notification, and/or metric of the food order.

Block S190 can similarly make some or all of the order and suborder details available to one or more participants in the group. For example, Block S190 can enable a participant to review his suborder through a participant interface within a food ordering application executing on a mobile computing device (e.g., a tablet or smartphone). The communication to a participant can include information relevant to the participant, such as confirmation that the participant's suborder was successfully recorded and logged into the aggregated food item order, that one or more food items in the participant's order did or did not meet a food item requirement (e.g., cost, nutritional content) specified in the food order, that an item in the participant's suborder will or will not be fulfilled, the total cost of the participant's suborder, etc.

Block S190 can be triggered upon completion of Block S150, Block S160, Block S170, or any combination therefore to inform the order coordination and/or participants of finalized food order details. Additionally or alternatively, Block S190 can transmit an order status including a summary of the order status for each participants (e.g., ordered or not ordered) to the order coordinator, to a participant, and/or to another relevant point person, such as at any suitable time prior to the order deadline and/or when requested by the order coordinator. However, Block S190 can function in any other way to communicate confirmation of the aggregated food item order to the order coordinator and confirmation of each suborder to each participant in the group of participants.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention defined in the following claims.

We claim:

1. A method for enabling group food orders, comprising:
receiving a food order from a order coordinator, the food order specifying a payment source and a group of participants;
storing a suborder for each participant on a server, each suborder including a default food item and accessible by a respective participant over a computer network;
generating a notification for a particular participant, the notification comprising a prompt to select an alternative food item for a particular suborder affiliated with the particular participant;
modifying the particular suborder, stored on the server, according to an alternative food item selected by the particular participant;
combining the modified particular suborder and a suborder of each other participant in the group into an aggregated food item order; and
charging the payment source for the aggregated food item order.

2. The method of claim 1, wherein receiving the food order comprises receiving the food order that further specifies a meal time, and further comprising setting an order deadline that is prior to the specified meal time.

3. The method of claim 2, wherein combining the suborders of the participants into the aggregated food item order comprises combining the suborders of the participants into an aggregated food item order in response to expiration of the order deadline.

4. The method of claim 2, wherein generating the notification for the particular participant comprises generating the notification that comprises the order deadline and a directive for the particular participant to select the alternative food item prior to expiration of the order deadline.

5. The method of claim 2, further comprising transmitting the notification to the particular participant prior to the order deadline.

6. The method of claim 5, wherein generating the notification for the particular participant comprises generating an email notification, and wherein transmitting the notification to the particular participant comprises transmitting the email notification to the particular participant.

7. The method of claim 2, wherein combining the suborders of the participants into the aggregated food item order comprises combining the alternative food item selected by the particular participant with a default food item in a second particular suborder affiliated with a second particular participant who did not select an alternative food item prior to expiration of the order deadline.

8. The method of claim 2, further comprising submitting the aggregated food item order to a food fulfillment service prior to the specified meal time.

9. The method of claim 1, wherein receiving the food order comprises receiving the food order that further specifies a maximum total cost for each suborder.

10. The method of claim 9, wherein modifying the particular suborder comprises modifying the particular suborder in accordance with a food item selection by the particular participant that falls within the maximum total cost for the particular suborder.

11. The method of claim 1, wherein generating the notification for the particular participant comprises recommending an alternative food item to the particular participant based on a food item order history of the particular participant.

12. The method of claim 1, further comprising adding the alternative food item selected by the particular participant to a list of favorite food items of the particular participant.

13. The method of claim 1, further comprising generating a second notification for the particular participant, the second notification comprising a reminder to select an alternative food item.

14. A method for enabling group food orders, comprising:
receiving a food order from a order coordinator, the food order specifying a group of participants, an order deadline, and a default food item for a suborder for each participant in the group of participants;
storing the suborder for each participant on a server, each suborder accessible by a respective participant over a computer network;
prompting a particular participant within the group of participants to select an alternative food item for a particular suborder affiliated with the particular participant;
modifying the particular suborder, stored on the server, according to an alternative food item selected by the particular participant;
in response to expiration of the order deadline, combining the modified particular suborder and a suborder of each other participant in the group into an aggregated food item order; and
submitting the aggregated food item order to a food fulfillment service.

15. The method of claim 14, wherein receiving a food order from a order coordinator comprises suggesting a vegetarian sandwich as a default food item for each suborder.

16. A method for enabling group food orders, comprising:
receiving a food order from a order coordinator, the food order specifying a payment source and a group of participants;
prompting each participant to select an alternative food item from a menu of available food items;
for each participant,
in response to selection of an alternative food item by the participant prior to an order deadline, adding the alternative food item to an aggregated food item order on behalf of the participant, and,
in response to no selection of an alternative food item by the participant prior to the order deadline, adding a default food item to the aggregated food item order on behalf of the participant;
storing the aggregated food item order on a server, the aggregated food item order reviewable by the order coordinator over a computer network; and
charging the payment source for the aggregated food item order.

17. The method of claim 16, wherein adding an alternative food item to the aggregated food item order comprises adding a food item, customized by a respective participant, to the aggregated food item order.

18. The method of claim 16, wherein prompting each participant to select an alternative food item comprises generating a notification for each participant, each notification comprising a link to an online menu interface that enables selection of an alternative food item.

19. The method of claim 16, further comprising generating the menu of available food items that comprises a custom limited menu of available food items based on an order setting input by the order coordinator.

20. The method of claim 16, wherein adding a default food item to the aggregated food item order on behalf of a participant comprises selecting a default food item for the participant based on a food item order history of the participant.

21. The method of claim 16, further comprising transmitting confirmation of the aggregated food item order to the order coordinator and transmitting confirmation of each suborder to each participant in the group of participants.
